(19) United States
(12) Patent Application Publication
(10) Pub. No.: US 2023/0340267 A1
(43) Pub. Date: Oct. 26, 2023

(54) SOY-SUBSTITUTED COLD-SET RESINS

(71) Applicant: AUBURN UNIVERSITY, AUBURN, AL (US)

(72) Inventors: BRIAN VIA, AUBURN, AL (US); SUJIT BANERJEE, MARIETTA, GA (US); OSEI A. ASAFU-ADJAYE, AUBURN, AL (US); ABIODUN O. ALAWODE, AUBURN, AL (US)

(73) Assignee: AUBURN UNIVERSITY, AUBURN, AL (US)

(21) Appl. No.: 18/304,855

(22) Filed: Apr. 21, 2023

Related U.S. Application Data
(60) Provisional application No. 63/333,727, filed on Apr. 22, 2022.

(51) Int. Cl. C08L 97/02

(52) U.S. Cl. CPC C08L 97/02

(57) ABSTRACT

Engineered wood products and binder compositions for cold-pressed applications are provided. Methods are also provided for formulating binders and producing the engineered wood products. The binder comprises a soy product and an adhesive formulation. The binders are prepared by mixing the soy product with the adhesive formulation prior to application to a lignocellulosic material to form the engineered wood. The present compositions and methods provide enhanced bonding and shorter holding time at decreased cost.

### CROSS-REFERENCE TO RELATED APPLICATIONS

Priority is hereby claimed to provisional application Ser. No. 63/333,727, filed Apr. 22, 2022, which is incorporated herein by reference.

### BACKGROUND

Binders for bonding wood are used in the manufacture of engineered wood products such as plywood, oriented strand board, particle board, glued laminated timber (i.e., “glulam”), and the like. A common characteristic of such products is that lignocellulosic substrates are bonded to each other using a synthetic adhesive or binder. The cost of the binders is a very significant component in the over-all cost of engineered wood products. Thus, decreasing the cost of the required binders is a fertile field of investigation. There are only two routes to decrease this cost—use less expensive components or use stronger binders of equal cost in lower concentrations.

Substituting conventional synthetic binders with cheaper alternatives has been the subject of much research. To date, however, such attempts have been unsuccessful in the marketplace because the resulting engineered wood products lacked the desired functional and/or structural properties. Accordingly, there is a long-felt and unmet need for a relatively inexpensive component or components that are compatible with existing binder formulation and can be mixed therein to reduce the cost of the overall formulation while maintaining or enhancing product performance.

Attempts have been made to use alternative adhesives for binder compositions. For example, animal-based materials, milk-based proteins, and certain types of vegetable protein have been used for binder compositions. However, such products have lacked the desired product features such as durability, water resistance, and strength.

Hot-press processes and cold-press processes are commonly used in the manufacture of engineered wood products. Hot-press processes are commonly used to produce particle board, multi-layer plywood, and the like. Cold-press processes are commonly used to produce thicker wood-based composite panels such as cross-laminated timbers, glue-laminated veneers, edge-bonded columns, and the like. These glulam-type products are typically made with dimensional lumber, which is too thick for effective external heat transfer. Economically, it is not desirable to use expensive, hot-press equipment when the set time is inordinately long—the economic advantage of using expensive thermosetting adhesives in the first place is that the bond can be set quickly. When forming thinner engineered wood products, a thermosetting adhesive can be cured very quickly, thus increasing production rates. Therefore, thicker wood-based composite panels are conventionally produced using an adhesive that can be cured at room temperature. Such binders are commonly called cold-set adhesives or a cold-set resins.

Prior to the application of adhesives, the layers may be pressure treated with preservatives to protect the wood from termites and other wood-degrading organisms. Retention of the chemicals in the wood is important to maintain the longevity of the treatment and to prevent leaching of the treatment chemicals into the surrounding environment. The treatment chemicals must be relatively non-toxic. A commonly used treatment is copper azole. The copper bonds to functional groups in wood, which inhibits leaching and increases fixation (Xue et al., 2016). However, copper azole treatment raises the pH of wood from about 5 to about 8 and increases its wettability (Alade et al, 2022). The increase in wettability promotes over-penetration of the adhesive into wood, which thins out the glue line and leads to a weaker bond.

### SUMMARY

Engineered wood products and methods of preparing the same in a cold-press process are provided herein according to the present disclosure. Embodiments of the engineered wood products include lignocellulosic material and a binder composition, wherein the binder composition comprises a soy product and an adhesive formulation.

The engineered wood products can be prepared by mixing a soy product and an adhesive formulation to form a binder, applying the binder to a lignocellulosic material, and pressing the lignocellulosic material applied with the binder under pressure to form a pressed wood composite. The binder comprises a soy product and an adhesive formulation.

Specifically, disclosed herein is a composite product comprising:
a lignocellulosic material; and
a binder composition comprising a mixture of a soy product and an adhesive formulation.

Preferably, the lignocellulosic material is pre-treated with a copper based preservative formulation. The preservative formulation may comprise copper azole.

The soy product is preferably selected from the group consisting of soy flour, soy meal, soy isolate, and a mixture thereof. Preferably, the soy product is in an amount between about 5 wt. % and about 50 wt. % of the binder composition.

The adhesive formulation is an emulsion polymer isocyanate comprising a polymer component and an isocyanate cross-linker component. In some embodiments, the adhesive formulation comprises the polymer component or the isocyanate cross-linker component of the emulsion polymer isocyanate. In some embodiments, the adhesive formulation comprises the polymer component and the isocyanate cross-linker component of the emulsion polymer isocyanate.

The binder composition may further comprise one or more additional components selected from the group consisting of dyes, pigments, processing aids, reinforcing agents, fillers, oils, viscosity-modifying agents, waxes, water, and the like.

The composite product includes, but is not limited to, glued laminated timber, cross laminated timber, strand laminated timber, laminated veneer lumber, cross laminated plywood mass timber, and edge-bonded columns.

Also disclosed herein is a method of preparing a pressed wood composite, comprising:
(a) mixing a soy product with an adhesive formulation to form a binder;
(b) applying the binder to a lignocellulosic material; and
(c) pressing the lignocellulosic material applied with the binder under pressure to form a composite.

Preferably, the method further comprises pre-treating the lignocellulosic material with a copper-based preservative formulation. The preservative formulation may comprise copper azole.

The soy product may be selected from the group consisting of soy flour, soy meal, soy isolate, and a mixture thereof. Preferably, the soy product is in an amount between about 5 wt. % and about 50 wt. % of the adhesive formulation.

The adhesive formulation is an emulsion polymer isocyanate comprising a polymer component and an isocyanate cross-linker component. In some embodiments, the adhesive formulation comprises the polymer component or the isocyanate cross-linker component of the emulsion polymer isocyanate. In some embodiments, the adhesive formulation comprises the polymer component and the isocyanate cross-linker component of the emulsion polymer isocyanate.

For mixing the soy product with the adhesive formulation, the soy product can be added to the adhesive formulation in a dry form. Alternatively, the soy product can be suspended in water to form a suspension and the suspension is mixed with the adhesive formulation. Preferably, the suspension has a moisture content of 5-80%.

The method comprises pressing two or more layers of the lignocellulosic material together to yield an engineered wood product. In some embodiments, the method comprises pressing at least three layers of the lignocellulosic material.

To form the engineered wood product, the lignocellulosic material is coated with or admixed with the binder composition, preferably at ambient temperature, and subjected to pressure to hold the lignocellulosic materials together while the adhesive cures.

The method may further comprise adding to the binder one or more of functional components selected from the group consisting of a dye, a pigment, a processing aid, a reinforcing agent, a filler, an oil, a viscosity-modifying agent, wax, and water.

The pressed wood composite made by the method includes, but is not limited to glued-laminated timber, cross-laminated timber, strand-laminated timber, laminated veneer lumber, cross-laminated plywood mass timber, edge-bonded columns, and the like.

The objects and advantages of the disclosure will appear more fully from the following detailed description of the preferred embodiment of the disclosure made in conjunction with the accompanying drawings.

### BRIEF DESCRIPTION OF THE DRAWINGS

FIG. 1A is a graph showing the effect of adding 20 wt % soy flour to a commercial EPI adhesive on the wet shear strength of pressure-treated wood. The Y-axis shows wet shear strength in MPa; the X-axis shows the amount of adhesive used to make the pressure-treated wood (g/m²).

FIG. 1B is a graph corresponding to the products evaluated in FIG. 1A, but here dry shear strength was determined. The Y-axis shows dry shear strength in MPa; the X-axis shows the amount of adhesive used to make the pressure-treated wood (g/m²).

Error bars represent one standard deviation.

### DETAILED DESCRIPTION

### Definitions

Unless defined otherwise, all technical and scientific terms used herein have the same meaning as commonly understood by one of ordinary skill in the art to which embodiments of the disclosure pertain. Many methods and materials similar, modified, or equivalent to those described herein can be used in the practice of the embodiments of the present disclosure without undue experimentation. The preferred materials and methods are described herein.

The embodiments of this disclosure are not limited to the specific engineered wood products or uses for the engineered wood products described herein, which can vary and are understood by skilled artisans. It is further to be understood that all terminology used herein is for the purpose of describing specific, exemplary versions only, and is not intended to be limiting in any manner or scope.

As used herein, the singular forms “a,” “an,” and “the” include plural referents unless the content clearly dictates otherwise.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

As used herein, the term “about” refers to ±10% of the variable referenced.

As used herein, the term “or” is an inclusive “or” operator and is equivalent to the term “and/or” unless the context clearly dictates otherwise.

All patents, patent publications, and peer-reviewed publications (i.e., “references”) cited herein are expressly incorporated by reference to the same extent as if each individual reference were specifically and individually indicated as being incorporated by reference. In case of conflict between the present disclosure and the incorporated references, the present disclosure controls.

The elements and method steps described herein can be used in any combination whether explicitly described or not, unless otherwise specified or clearly implied to the contrary by the context in which the referenced combination is made.

All combinations of method steps as used herein can be performed in any order, unless otherwise specified or clearly implied to the contrary by the context in which the referenced combination is made.

The system disclosed herein may comprise, consist of, or consist essentially of the various steps and elements disclosed herein. The disclosure provided herein may be practiced in the absence of any element or step which is not specifically disclosed herein.

The term “lignocellulosic material” as used herein refers to pieces of wood used to make engineered wood products and includes, but is not limited to, wood strands, wood particles, wood plies, wood fibers, wood pulp, wood chips, wood boards and posts, dimensional lumber, etc.

The term “synthetic resin” is defined herein as a resin of non-biological origin prepared by polymerization of monomers of synthetic, typically hydrocarbon-based, monomers.

The term “soy product” refers to soy flour and/or soy meal, including their unmodified forms and mixtures thereof.

The term “unmodified soy flour” describes soy flour that has not been modified by functionalization, polymerization, copolymerization, cross-linking, or otherwise derivatized.

The term “unmodified soy meal” describes soy meal that has not been modified by functionalization, polymerization, copolymerization, cross-linking, or otherwise derivatized.

“Emulsion polymer isocyanates adhesives” (“EPI” adhesives) are conventional, commercially available, two-part adhesives. EPI adhesives comprise a two-component adhesive system; (1) a water-based polymer that is cured with; (2) a cross-linking agent (commonly called a hardener) such as an isocyanate. EPI adhesive formulations are available from several global suppliers, including Dynea A S (Lillestrøm, Norway), Arkema USA, Inc. (King of Prussia, Pennsylvania); Bostik (Colombes, France), AkzoNobel (Nashville, Tennessee), Ashland Global Specialty Chemicals Inc. (Wilmington, Delaware), and many others.

### Binder Compositions:

Disclosed herein is a binder composition for preparing a pressed wood composite. The binder composition comprises a mixture of a soy product and an adhesive formulation.

The soy product is selected from the group consisting of soy flour, soy meal, soy isolate, and a mixture thereof. In some embodiments, the soy product is unmodified soy flour, or unmodified soy meal.

The soy product can comprise between about 1 wt. % and about 80 wt. % of the binder composition. In a preferred embodiment, the soy product comprises between about 5 wt. % and about 50 wt. % of the binder composition.

The adhesive formulation can be any synthetic resin that is suitable for application in a cold-press process. In one embodiment, the adhesive formulation is an emulsion polymer isocyanate (EPI). EPI adhesives are commonly used in cold-pressing. EPI is a two-component adhesive system consisting of a water-based polymer such as polyvinyl alcohol and an isocyanate cross-linker (Grostad and Pederson, 2010). The adhesive formulation used herein can be a one-component EPI (i.e., a water-based polymer or an isocyanate cross-linker), or a two-component EPI.

The adhesive formulation can comprise between about 20 wt. % to about 99 wt. % of the binder composition. In a preferred embodiment, the adhesive formulation comprises between about 50 wt. % and about 95 wt. % of the binder composition.

The binder composition can optionally include other functional components such as a dye, a pigment, a processing aid, a reinforcing agent, a filler, an oil, a viscosity-modifying agent, wax, and water. The optional functional components can be added in an amount sufficient to provide the desired functional property, e.g., color or viscosity. Generally, the optional functional components can be added in an amount between about 0 wt. % and about 30 wt. % of the binder composition, preferably between about 0.01 wt. % and about 20 wt. %.

The binder compositions can be prepared as a premix or mixed together with the other components of the wood-containing composite. For example, the components of the binder compositions can be mixed directly together with other components of the wood-containing composite. The components in the binder composition can be prepared as a premix. For example, the soy product and the adhesive formulation can be mixed together to form a premix. Alternatively, the soy product, the adhesive formulation, and optional functional components can be mixed together as a premix. In some embodiments, dry soy product is added to the adhesive formulation. In some embodiments, a soy product suspension in water is mixed with the adhesive formulation. Preferably, the moisture content of the soy product suspension is between about 5 wt. % to about 80 wt. %. The binder compositions, including, but not limited to the premix, can be in powder form, liquid form, slurry form, or gel form. Where interaction between soy product and the adhesive components leads to undesirable properties, the soy product and the adhesive can be applied individually and separately to the lignocellulosic matrix.

### Methods of Preparing Pressed Wood Composites:

Disclosed herein is a method of preparing a pressed wood composite. The method comprises mixing a soy product with an adhesive formulation to form a binder, applying the binder to a lignocellulosic material, and pressing the lignocellulosic material applied with the binder under pressure to form a composite.

The soy product and the adhesive formulation can be mixed using any suitable method to form a binder. For example, dry soy product can be added to the adhesive formulation; or alternatively, a soy product suspension in water can be mixed with the adhesive formulation.

Adding soy products to the adhesive formulation provides a cost benefit comparing to previous synthetic adhesive formulations. Application of the soy-amended binder maintains desired properties of the wood composites. As shown in the Examples below, the dry strength of the soy-amended board increases with increasing soy flour content. Using Use of unmodified soy product, e.g., unmodified soy flour or unmodified soy meal, can further reduce the cost because expensive pre-application treatments such as crosslinking with other agents are not needed.

Preferably, the binder is applied to a surface of the lignocellulosic material. The applying step can be performed by methods including, but not limiting to, spraying, rolling, submerging, pouring, extruding, and gravity applications. In some embodiments, the components of the binder composition can be separately mixed with the lignocellulosic material and subsequently combined to form the binder composition and lignocellulosic mixture.

The method may comprise pressing multiple layers of the lignocellulosic materials. In some embodiments, the method comprises pressing at least three layers of the lignocellulosic materials.

The adhesive formulation of the binder is configured to be cold curing, such that the pressing is performed under room temperature without heating.

Preferably, the lignocellulosic material is pre-treated with a preservative formulation to protect the wood from termites and other wood degrading organisms. The preservative formulation may be a copper based preservative formulation, such as copper azole. The soy product comprised in the binder can react with the copper, reinforce the bond line, and increases the strength of the wood composites.

Also provided herein is a composite product made by the methods disclosed herein. The composite product comprises a lignocellulosic material and a binder composition comprising a mixture of a soy product and an adhesive formulation. In some embodiments, the composite product is glued laminated timber, cross laminated timber, strand laminated timber, laminated veneer lumber, cross laminated plywood mass timber, or edge-bonded columns.

The following examples, which are merely illustrative of the present disclosure, demonstrate application of the present disclosure, as well as demonstrate the benefits associated herewith.

### EXAMPLES

Embodiments of the present disclosure are further defined in the following non-limiting Examples. These Examples, while indicating certain versions of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

A commercial EPI resin adhesive was used. (“ISOSET”®-brand WD3-A320 emulsion polymer isocyanate, marketed by Ashland Global Specialty Chemicals Inc. (Wilmington, Delaware) in the United States. “ISOSET”® is a registered trademark of Arkema France, Colombes, France.) The adhesive is applied with an “ISOSET”®-brand CX-47 crosslinker in various ratios depending on product requirements. A mixture comprising 1 part WD-A320 polymer and 3 parts CX-47 was prepared. A 1:2 suspension of soy flour (wt/wt) in water was mixed into the adhesive/crosslinker formulation at various concentrations and spread on 1″×1″ pine veneer coupon at a spread rate of 200 g/m². The coupon was covered with a second coupon that was not treated with the adhesive. The coupons were pressed at 300 psi for 30 to 90 minutes at room temperature.

The coupons were then tested according to the ASTM D 1002 standard, which is commonly referred to as the lap shear test. The glued samples were also soaked in water for 24 hours and the lap shear measurements were repeated with the wet samples. No delamination occurred for any of the samples. The strength values (dry and wet) are reported in Table 1. Overall, the dry strength of the soy-amended specimens increased with increasing soy flour substitution, whereas the wet strength remained largely unchanged.

TABLE 1
Lap shear results (MPa)¹
Percent soy flour substitution in “Isoset” ®-brand adhesive

| | | | | |
|---|---|---|---|---|
| 0 | 20 | 30 | 40 | 50 |

30 min press

| | | | | | |
|---|---|---|---|---|---|
| Dry shear | 1.6 ± 0.1 | 2.59 ± 0.1 | 2.7 ± 0.1 | 2.6 ± 0.2 | 2.9 ± 0.2 |
| Wet shear | 0.27 ± 0.08 | 0.63 ± 0.09 | 0.6 ± 0.1 | 0.6 ± 0.2 | 0.5 ± 0.1 |

60 min press

| | | | | | |
|---|---|---|---|---|---|
| Dry shear | 2.20 ± 0.08 | 2.9 ± 0.1 | 3.0 ± 0.1 | 3.03 ± 0.1 | 3.6 ± 0.1 |
| Wet shear | 0.8 ± 0.2 | 0.7 ± 0.1 | 0.8 ± 0.1 | 0.56 ± 0.06 | 0.6 ± 0.1 |

90 min press

| | | | | | |
|---|---|---|---|---|---|
| Dry shear | 2.6 ± 0.3 | 3.1 ± 0.2 | 3.0 ± 0.2 | 2.9 ± 0.2 | 2.56 ± 0.01 |
| Wet shear | 0.6 ± 0.2 | 1.3 ± 0.3 | 1.0 ± 0.1 | 0.6 ± 0.1 | 0.50 ± 0.09 |

¹5 replicates

### Example 2

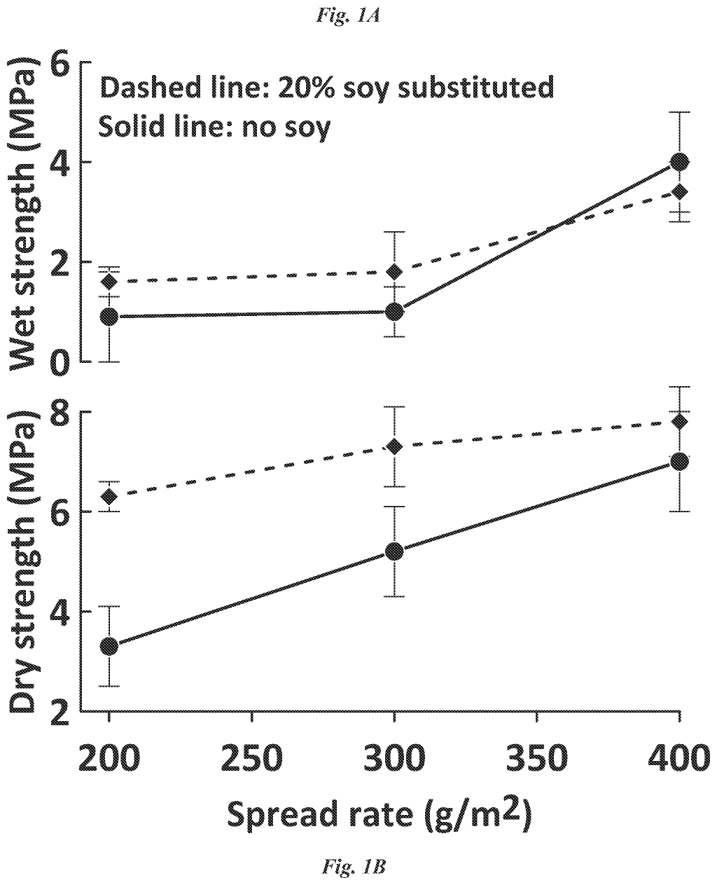

Twenty percent of the EPI resin prepared in Example 1 (i.e., resin plus crosslinker) was replaced with soy flour pre-mixed with 3 parts of water by weight of the soy flour. The EPI-soy resin composition was applied with a hand roller at different spread rates on 305×38 mm Southern yellow pine wood samples. The samples were pre-treated with micronized copper azole. The samples were cold pressed at 1.5 MPa for 90 minutes and tested according to ASTM D 905. Wet samples were soaked in water for 24 hours prior to testing. The results are presented in FIGS. 1A and 1B, which show that the dry strength of the soy-treated samples (FIG. 1B) was much higher than those for the control sample. The wet strength was about the same (FIG. 1A).

The advantages of the disclosed composition are lower resin costs (because significantly less resin is required to achieve a significantly stronger bond) and a shorter holding time. Typically, the dry strength of composite wood products increases over about 2 weeks post-manufacture. However, because the dry strength of the wood pressed with soy-substituted resin is much higher than that of the no-soy control, the holding time can be shortened, which results in cost savings due to decreased inventory holding times.

### REFERENCES

A. A. Alade, Z. Naghizadeh, C. B. Wessels. Characterizing surface adhesion-related chemical properties of copper azole and disodium octaborate tetrahydrate-impregnated Eucalyptus grandis wood. J. Adhes. Sci. Technol. (2022). doi.org/10.1080/01694243.2022.2125208.
K. Grostad, A. Pederson. Emulsion polymer isocyanates as wood adhesive: a review. J. Adhes. Sci. Technol. 24, 1357-1381 (2010).
W. Xue, J. N. R. Ruddick, P. Kennepohl. Solubilisation and chemical fixation of copper (II) in micronized copper treated wood, Dalton Trans. 45, 3679 (2016).

What is claimed is:

1. A composite product comprising:
a lignocellulosic material in two or more discrete parts, bound together with
a binder composition comprising a mixture of a soy product and an adhesive formulation.

2. The composite product of claim 1, wherein the lignocellulosic material is pre-treated with a copper-based preservative formulation.

3. The composite product of claim 2, wherein the preservative formulation comprises copper azole.

4. The composite product of claim 1, wherein the soy product is selected from the group consisting of soy flour, soy meal, soy isolate, and mixtures thereof.

5. The composite product of claim 1, wherein the soy product is in an amount between about 5 wt. % and about 50 wt. % of the binder composition.

6. The composite product of claim 1, wherein the adhesive formulation is an emulsion polymer isocyanate comprising a polymer component and an isocyanate cross-linker component.

7. The composite product of claim 1, wherein the binder composition further comprises one or more components selected from the group consisting of a dye, a pigment, a processing aid, a reinforcing agent, a filler, an oil, a viscosity-modifying agent, wax, and water.

8. The composite product of claim 1, wherein the composite product is glued-laminated timber, cross-laminated timber, strand-laminated timber, laminated veneer lumber, cross-laminated plywood mass timber, or edge-bonded columns.

9. A method of preparing a wood composite, comprising:
(a) mixing a soy product and an adhesive formulation to form a binder;
(b) applying the binder to a lignocellulosic material; and
(c) pressing the lignocellulosic material of step (b) under pressure with one or more additional piece(s) of lignocellulosic material to form the pressed wood composite.

10. The method of claim 9, further comprising pre-treating the lignocellulosic material with a copper-based preservative formulation.

11. The method of claim 10, wherein the preservative formulation comprises copper azole.

12. The method of claim 10, wherein the soy product is selected from the group consisting of soy flour, soy meal, soy isolate, and a mixture thereof.

13. The method of claim 10, wherein the soy product is in an amount between about 5 wt. % and about 50 wt. % of the binder.

14. The method of claim 10, wherein the adhesive formulation is an emulsion polymer isocyanate comprising a polymer component and an isocyanate cross-linker component.

15. The method of claim 12, wherein the soy product is added to the adhesive formulation in a dry form.

16. The method of claim 12, wherein the soy product is suspended in water to form a suspension and the suspension is mixed with the adhesive formulation.

17. The method of claim 16, wherein the suspension has a moisture content of 5-80%.

18. The method of claim 9, comprising pressing multiple layers of the lignocellulosic material.

19. The method of claim 18, comprising pressing at least three layers of the lignocellulosic material.

20. The method of claim 9, wherein the lignocellulosic material applied with the binder is pressed at room temperature without heating.

21. The method of claim 9, further comprising adding to the binder one or more of functional components selected from the group consisting of a dye, a pigment, a processing aid, a reinforcing agent, a filler, an oil, a viscosity-modifying agent, wax, and water.

22. The method of claim 9, wherein the pressed wood composite is glued laminated timber, cross laminated timber, strand laminated timber, laminated veneer lumber, cross laminated plywood mass timber or edge-bonded columns.
